(19) United States
(12) Patent Application Publication
(10) Pub. No.: US 2006/0012170 A1
(43) Pub. Date: Jan. 19, 2006

(54) Fitter clamp for a pipe

(76) Inventor: Chang Log Jeong, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/523,992

(22) PCT Filed: Aug. 8, 2003
(86) PCT No.: PCT/KR03/01596

§ 371 Date: Feb. 9, 2005

(30) Foreign Application Priority Data
Aug. 10, 2002 (KR) 2020020023971

(51) Int. Cl. F16L 37/00

(52) U.S. Cl. 285/307

(57) ABSTRACT

A pipe fitter clamp fixedly installed between a female bracket and a male bracket which are coupled each other to allow forward insertion of a pipe and prevent backward escape of the pipe and pressing and fixing the inserted pipe includes a ring shape body having an inner diametric portion contacting the pipe and at least one allowance slit formed in an outer diametric direction from the inner diametric portion to enable diametric extension of the inner diametric portion, and at least one allowance slit extension portion protruding from the body to have an extended allowance slit in which the length of the allowance slit is extended over an outer diameter of the body, extended and connected to have a shape of encompassing an outside of the extended allowance slit, and bent by a predetermined angle with respect to the body so as to be elastically deformed.

### BACKGROUND OF THE INVENTION

1. Field of the Invention

The present invention relates to a pipe fitter clamp for a pipe, and more particularly, to a pipe fitter clamp for a pipe providing a more firm holding force by increasing a contact area of a pipe.

2. Description of the Related Art

In general, as shown in FIGS. 1 and 2, a conventional pipe fitter clamp 100 includes a vertical body 110 and a circumferential body 120, as shown in FIG. 1, which is fixedly installed by a guide 4 and an O-ring 5 between a female bracket 2 and a male bracket 3 coupled each other to allow forward insertion of a pipe 1 but prevent backward escape thereof.

Here, the vertical body 110 is cylindrical fixed to an inner diametric step 3a of the male bracket 3. The circumferential body 120 has an inclined shape and is split into a plurality of pieces by an allowance slit 120a radially arranged from the inner diameter of the circumferential body 120 so as to allow forward insertion of the pipe 1 but prevent backward escape thereof.

That is, the allowance slit 120a is formed to cross the circumferential body 120 so that, when the pipe 1 is forwardly inserted, the respective pieces of the circumferential body 120 are elastically deformed to always hold the pipe 1 by a restoring force.

However, the length of the conventional pipe fitter clamp 100 cannot be increased since the length of the allowance slit 120a is restricted by the circumferential body 120. Accordingly, in order for the respective pieces of the circumferential body 120 to have sufficient elasticity, the number of the allowance slit 120a must be increased. When the number of the allowance slit 120a is increased, a space between the pieces increases due to the allowance slit 120a so that a contact area of the pipe 1 decreases. Thus, to increase a pipe holding force, a saw-toothed blade 120b triangularly cut is formed on a contact surface of the circumferential body 120 contacting the pipe 1. However, the saw-toothed blade 120b only penetrates the pipe 1 leaving a cut. Actual effect of increasing a holding force is slight.

Therefore, the conventional pipe fitter clamp 100 is not stable since the holding force is weak due to a small contact area of the pipe 1. Moreover, since the saw-toothed blade 120b leaves a cut on the surface of the pipe 1, the pipe 1 is damaged or leaks fluid material.

Furthermore, an additional process of processing the saw-toothed blade 120b is needed. The manufacturing cost increases due to deformation in the thickness or shape generated during drawing work to form the vertical body 110 which is cylindrical. The productivity, precision, and quality of products are remarkably lowered. There is a limit in the drawing work when product of various specifications are manufactured.

### SUMMARY OF THE INVENTION

To solve the above problems, it is an object of the present invention to provide a pipe fitter clamp in which the length of an allowance slit is increased by reducing the number of the allowance slit so that the contact area of a pipe is increased, thus providing stability and a firm holding force, and which does not leave cuts on the surface of the pipe so that damage to the pipe or leakage of fluid material can be prevented.

Also, it is another object of the present invention to provide a pipe fitter clamp which does not need an additional process such as a blade process, can be easily manufactured by a cut process and a bending process using a plate so that the manufacturing cost can be reduced, increases productivity, improves precision and quality of a product with uniform thickness or shape, and facilitates manufacturing of products of various specifications.

To achieve the above objects, there is provided a pipe fitter clamp fixedly installed between a female bracket and a male bracket which are coupled each other to allow forward insertion of a pipe and prevent backward escape of the pipe and pressing and fixing the inserted pipe, the pipe fitter clamp comprising a ring shape body having an inner diametric portion contacting the pipe and at least one allowance slit formed in an outer diametric direction from the inner diametric portion to enable diametric extension of the inner diametric portion, and at least one allowance slit extension portion protruding from the body to have an extended allowance slit in which the length of the allowance slit is extended over an outer diameter of the body, extended and connected to have a shape of encompassing an outside of the extended allowance slit, and bent by a predetermined angle with respect to the body so as to be elastically deformed.

A circumferential surface of the body has an inclined surface inclined at a predetermined angle to resist backward escape of the inserted pipe, the allowance slit is radially formed at an identical angle and identical distance with respect to the body, the allowance slit extension portion has an extended allowance slit connected to the allowance slit of the body, bent by a predetermined angle with respect to the body, and has a round hole formed an end portion of the extended allowance slit to prevent concentration of stress and improve deformability, and the body and the allowance slit extension portion are manufactured of a stainless steel spring plate which is thermally treated so as to be elastically deformed with each other.

The pipe fitter clamp further comprises an auxiliary extension portion having the same outer side as that of the allowance slit extension portion, bent by the same angle as that of the allowance slit extension portion so as to be elastically deformable, and having no allowance slit.

The body and the allowance slit extension portion are formed by punching an inner diametric portion of the body in a stainless steel spring plate, forming an allowance slit by radially cutting the inner diametric portion at an identical angle, lifting off an outer portion of the body and the allowance slit extension portion except for an connection portion, bending the allowance slit extension portion with respect to the body fixed to the steel plate by the connection portion, and cutting the connection portion to lift off the body and the allowance slit extension portion.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating a conventional pipe fitter clamp;

FIG. 2 is a sectional view illustrating a state in which the pipe fitter clamp of FIG. 1 is coupled between the female bracket and the male bracket;

FIG. 3 is a perspective view illustrating a pipe fitter clamp according to a preferred embodiment of the present invention;

FIG. 4 is a perspective view illustrating a pipe fitter clamp according to another preferred embodiment of the present invention;

FIG. 5 is a sectional view illustrating a state in which the pipe fitter clamp of FIG. 4 is coupled between the female bracket and the male bracket;

FIG. 6 is an enlarged sectional view of the portion A of FIG. 5;

FIGS. 7 through 11 are enlarged sectional views illustrating various preferred embodiments of FIG. 6;

FIG. 12 is a perspective view illustrating a pipe fitter clamp according to yet another preferred embodiment of the present invention; and

FIG. 13 is a side sectional view illustrating the operation state of FIG. 12.

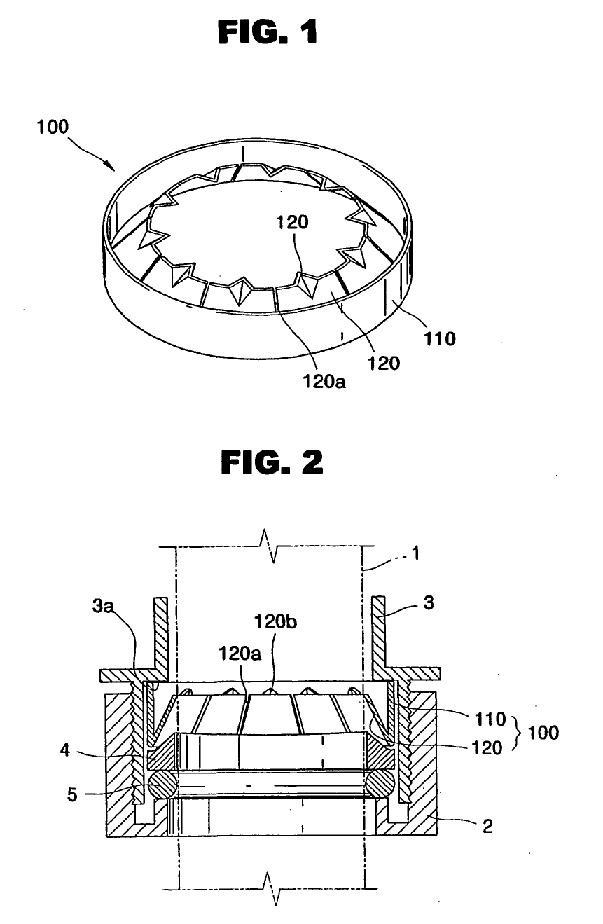

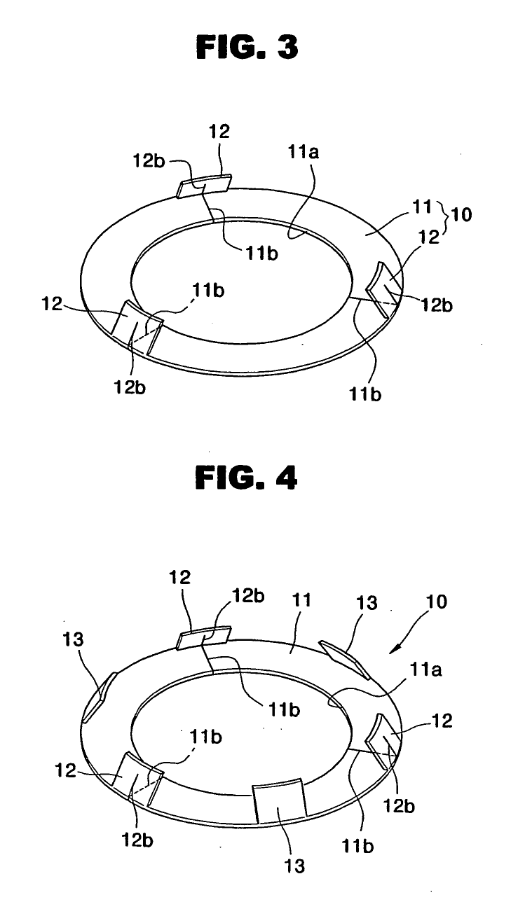

### DETAILED DESCRIPTION OF THE INVENTION

Hereinafter, pipe fitter clamps according to preferred embodiments of the present invention will be described in detail with reference to the accompanying drawings.

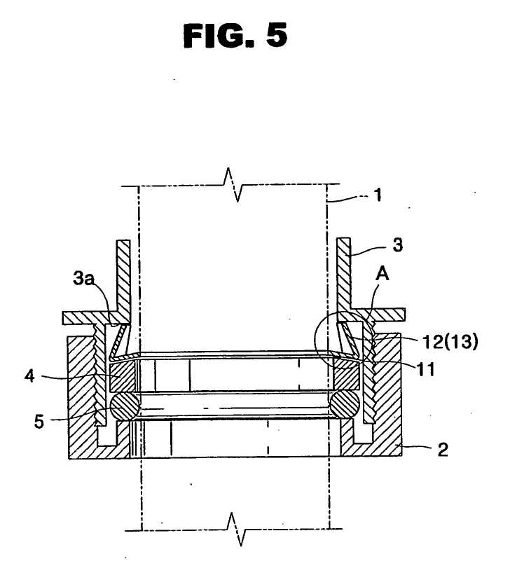

First, as shown in FIG. 3, a pipe fitter clamp 10 according to a preferred embodiment of the present invention is fixedly installed between a female bracket 2 and a male bracket 3 of FIG. 5 coupled each other to allow forward insertion of a pipe 1 and prevent backward escape thereof to press and fix the inserted pipe 1. The pipe fitter clamp 10 includes a body 11 and an allowance slit extension portion 12.

That is, as shown in FIG. 3, the body 11 has an inner diametric portion 11a contacting the pipe 1 and has a ring shape where at least one (three in the drawing) allowance slit 11b is formed from the inner diametric portion 11a toward the outer diametric side so that the diameter of the inner diametric portion 11a can be extended. A circumferential surface of the body 11 has an inclined surface inclined at a predetermined angle to resist the backward escape of the inserted pipe 1. The allowance slit 11b is formed by radially cutting the body 11 at the identical angle and the identical distance.

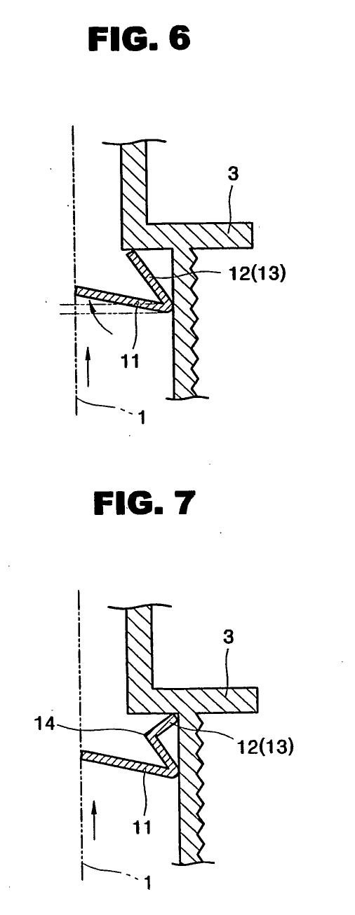

Also, the allowance slit extension portion 12 protrudes outwardly from the body 11 to have an extended allowance slit 12b, such that the length of the allowance slit 11b is extended over the outer diameter of the body 11, and encompass the extended allowance slit 12b. Also, the allowance slit extension portion 12 is bent by a predetermined angle with respect to the body 11 so as to be elastically deformed. The extended allowance slit 12b is connected to the allowance slit 11b of the body 11. As shown in FIGS. 5 and 6, the allowance slit extension portion 12 is bent by a predetermined angle with respect to the body 11.

In the meantime, although not shown in the drawings, a round hole may be formed at the end portion of the extended allowance slit 12b to prevent concentration of stress and improve deformability. The technology concerning the round hole is a technology applied to a round hole formed at the end tip of an ink slit of the tip where ink adheres in a fountain pen, which is a technology changed and modified by those skilled in the art.

Also, the body 11 and the allowance slit extension portion 12 are made of a stainless steel spring plate which is thermally treated so that they can be elastically deformed.

Thus, as shown in FIGS. 5 and 6, the body 11 and the allowance slit extension portion 12 are disposed between the female bracket 2 and the male bracket 3. When the female bracket 2 and the male bracket 3 closely contact each other, the pipe 1 is sealed by the O-ring 5 and simultaneously pressed by the guide

Here, the end portion of the allowance slit extension portion 12 is supported by being caught by an inner diametric step 3a of the male bracket 3. The body 11 is manufactured to have a diameter less than the outer diameter of the pipe 1 so as to be installed around the pipe 1 by being pushed in a direction along the pipe 1.

When the pipe 1 is forwardly inserted, although the number of the allowance slits is small, the body 11 is sufficiently elastically deformed by the long extended allowance slit 11b extended to the allowance slit extension portion 12 and the inner diametric portion 11a of the body 11 can firmly hold the outer diametric surface of the pipe 1 by a restoration force.

Here, the inner diametric portion 11a of the body 11 has a small number of the allowance slit 11b and simultaneously has a curved shape where the conventional saw-toothed blade is not formed. Thus, the contact area of the pipe 1 is increased so that the pipe 1 can be stably and firmly hold.

In the meantime, as shown in FIG. 4, a pipe fitter clamp 10 according to another preferred embodiment of the present invention may further include an auxiliary extension portion 13, in addition to the body 11 and the allowance slit extension portion 12. The auxiliary extension portion 13 has the same outer shape as that of the allowance slit extension portion 12 and is bent at the same angel as that of the allowance slit extension portion 12 so as to be elastically deformed, while having neither allowance slit 11b nor extended allowance slit 12b.

Thus, by minimizing the number of the allowance slit 11b while maximizing the elastic restoration force between the body 11 and the allowance slit extension portion 12/the auxiliary extension portion 13, the holding force with respect to the pipe 1 can be reinforced.

In the meantime, as shown in FIG. 6, the body 11 and the allowance slit extension portion 12/the auxiliary extension portion 13 can be manufactured by a simple first bending (shown in FIG. 6) only. In addition, as shown in FIGS. 7 through 11, they can be formed by being bent in a number of times at a variety of angles.

That is, as shown in FIG. 7, to make support by the inner diametric step 3a of the male bracket 3 further firm, the allowance slit extension portion 12/the auxiliary extension portion 13 may have an elastic bending portion 14 which is secondly bent at a predetermined angle, at an end portion thereof contacting the inner diametric step 3a of the male bracket 3.

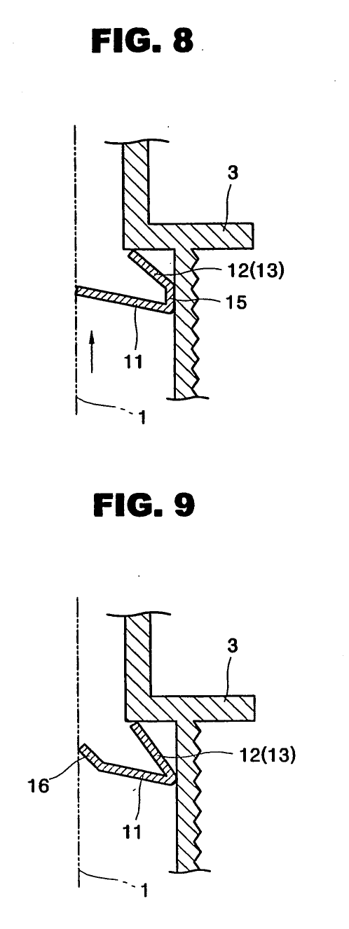

Also, as shown in FIG. 8, to make the support of the inner diametric step 3a of the male bracket 3 more firm, the allowance slit extension portion 12/the auxiliary extension portion 13 may have a connection bending portion 15 which is a two-times bending formed at a rear end portion (that is, between the body and the allowance slit extension portion/the auxiliary extension portion) connected to the body 11.

Also, as shown in FIG. 9, to further increase a frictional force to the pipe 1, the body 11 may have a blade bending portion 16 which is two-times bending formed at the inner diametric surface contacting the pipe 1.

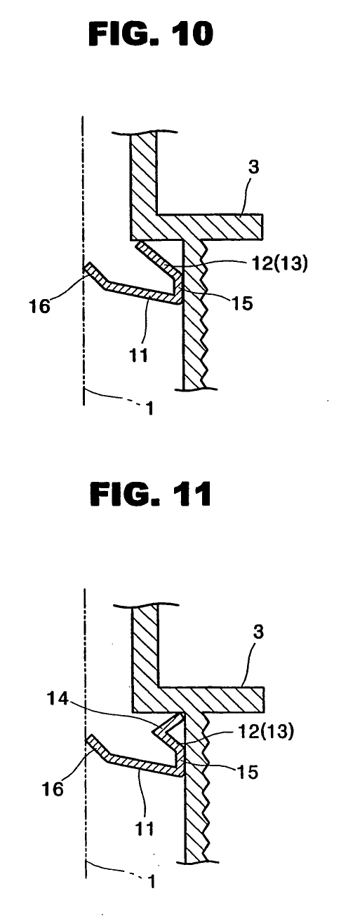

In addition, as shown in FIG. 10, a three-times bending structure including both the connection bending portion 15 and the blade bending portion 16 is possible. As shown in FIG. 11, a four-times bending structure including all the elastic bending portion 14, the connection bending portion 15, and the blade bending portion 16 is possible.

The shape and type of the bending can be changed and modified by those skilled in the art within the technical scope of the present invention.

Meanwhile, in the manufacturing process of the body and the allowance slit extension portion, first, the inner diametric portion 11a of the body 11 is punched in a stainless steel spring plate. The allowance slit 11b and the extended allowance slit 12b are formed by radially cutting the inner diametric portion 11a at the identical angle. The outer portion of the body 11 and the allowance slit extension portion 12 is lifted off. Next, the allowance slit extension potion 12 are bent with respect to the body 11. Finally, the connection portions are cut so that the body 11 and the allowance slit extension portion 12 are lifted off.

Thus, since the pipe fitter clamp is manufactured by cutting and bending a thin plate without using the drawing process, irregular thickness or deformation of the shape which are usually generated during the drawing process do not generated. Thus, very precise quality products can be manufactured and productivity and production cost can be remarkably reduced due to the simplified process.

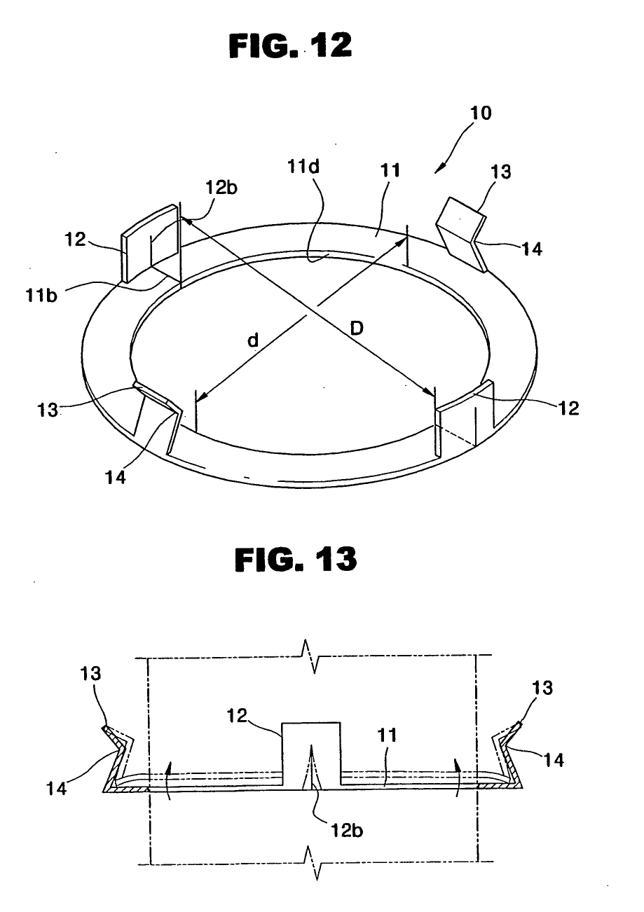

In the meantime, as shown in FIG. 12, a pipe fitter clamp 1 according to another preferred embodiment of the present invention includes an oval inner diametric hole 11d having a narrower diameter d and a wider diameter D so that the pipe 1 can be forcedly inserted due to the deformation of the body. Two allowance slits 11b and extended allowance slits 12b are formed in a wider diametric D portion.

Also, the allowance slit extension portion 12 is vertically bent at the wider diametric D portion to encompass the extended allowance slit 12b to function as the center of rotation. The auxiliary extension portion 13 has an elastic bending portion 14 which is formed by bending the auxiliary extension portion 13 at a narrower diameter d portion so that a restoration force is generated in a direction in which the pipe 1 is forcedly inserted by contacting the inner diametric step 3a of the male bracket 3.

Accordingly, as shown in FIG. 13, when the pipe 1 is forcedly pushed, the elastic bending portion 14 is vertically bent so that the extended allowance slit 12b is open wide with respect to the allowance slit extension portion 12 supported by the inner diametric step 3a of the male bracket 3. Thus, the pipe 1 can be inserted as the inner diameter, that is, the narrower diameter d, of the body 11 is deformed to be wide.

Here, as the body 11 is bent, a restoration force toward the pipe 1 is generated and simultaneously, as the auxiliary extension portion 13 is compressed, a restoration force toward the pipe 1 is generated as well. Thus, the inner hole 11d of the body 11 can firmly fix the pipe 1 by pressing the pipe 1 in both directions.

While this invention has been particularly shown and described with reference to preferred embodiments thereof, it will be understood by those skilled in the art that various changes in form and details may be made therein without departing from the spirit and scope of the invention as defined by the appended claims.

For example, although in the preferred embodiments of the present invention three allowance slit extension portions and three auxiliary extension portions are formed in the ring shaped body, the shape of the body may be changed and the number of the allowance slit extension portion and the auxiliary extension portion can be changed from at least one.

Thus, the scope of claiming rights in the present invention will be defined not by the scope of the above description, but by the following claims and the technical concept.

As described above, according to the pipe fitter clamp according to the present invention, stability and firm holding force are provided by increasing the contact area of the pipe. Since severe cuts are not generated on the surface of the pipe so that damage to the pipe or leakage of fluid material can be prevented. An additional process such as a blade process is not needed. Products can be easily manufactured by only a cut process and a bending process using a plate. Thus, the manufacturing cost can be reduced, productivity is increased, precision and quality of a product is improved due to uniform thickness or shape, and products of various specifications can be easily manufactured.

What is claimed is:

1. A pipe fitter clamp fixedly installed between a female bracket and a male bracket which are coupled each other to allow forward insertion of a pipe and prevent backward escape of the pipe and pressing and fixing the inserted pipe, the pipe fitter clamp comprising:
a ring shape body having an inner diametric portion contacting the pipe and at least one allowance slit formed in an outer diametric direction from the inner diametric portion to enable diametric extension of the inner diametric portion; and
at least one allowance slit extension portion protruding from the body to have an extended allowance slit in which the length of the allowance slit is extended over an outer diameter of the body, extended and connected to have a shape of encompassing an outside of the extended allowance slit, and bent by a predetermined angle with respect to the body so as to be elastically deformed.

2. The pipe fitter clamp as claimed in claim 1, wherein a circumferential surface of the body has an inclined surface inclined at a predetermined angle to resist backward escape of the inserted pipe, the allowance slit is radially formed at an identical angle and identical distance with respect to the body, the allowance slit extension portion has an extended allowance slit connected to the allowance slit of the body, bent by a predetermined angle with respect to the body, and has a round hole formed an end portion of the extended allowance slit to prevent concentration of stress and improve deformability, and the body and the allowance slit extension portion are manufactured of a stainless steel spring plate which is thermally treated SO as to be elastically deformed with each other.

3. The pipe fitter clamp as claimed in claim 1, further comprising an auxiliary extension portion having the same outer side as that of the allowance slit extension portion, bent by the same angle as that of the allowance slit extension portion so as to be elastically deformable, and having no allowance slit.

4. The pipe fitter clamp as claimed in claim 3, wherein the allowance slit extension portion and the auxiliary extension portion further comprise an elastic bending portion bent at an end portion contacting an inner diametric step of the male bracket and/or a connection bending portion formed at a rear end portion connected to the body, and the body further comprises a blade bending portion bent on an inner diametric surface contacting the pipe.

5. The pipe fitter clamp as claimed in claim 1, wherein the body and the allowance slit extension portion are formed by punching an inner diametric portion of the body in a stainless steel spring plate, forming an allowance slit by radially cutting the inner diametric portion at an identical angle, lifting off an outer portion of the body and the allowance slit extension portion except for an connection portion, bending the allowance slit extension portion with respect to the body fixed to the steel plate by the connection portion, and cutting the connection portion to lift off the body and the allowance slit extension portion.

6. The pipe fitter clamp as claimed in claim 3, wherein an oval inner diametric hole having a narrower diameter d and a wider diameter D is formed in the body so that the pipe is forcedly caught due to the deformation of the body, two allowance slits are formed in the wider diameter D portion, the allowance slit extension portion is vertically bent in the wide diameter D portion to encompass the allowance slit to work as a center of rotation, and the auxiliary extension portion has an elastic bending portion which is formed at a narrower diameter d portion by bending an end portion of the auxiliary extension portion so as to provide a restoration force in a direction in which the pipe is forcedly caught by contacting the inner diametric step of the male bracket.
